(19) United States
(12) Patent Application Publication
(10) Pub. No.: US 2015/0127300 A1
(43) Pub. Date: May 7, 2015

(54) Sensor Selection Based on Context and Policy

(71) Applicant: Microsoft Corporation, Redmond, WA (US)

(72) Inventors: Jason B. Bluming, Seattle, WA (US); Matthew James Parker, Bellevue, WA (US); Kimberly D. A. Hallman, Bellevue, WA (US); Natarajan Kurian Seshan, Bothell, WA (US)

(73) Assignee: Microsoft Corporation, Redmond, WA (US)

(21) Appl. No.: 14/285,119

(22) Filed: May 22, 2014

Related U.S. Application Data
(60) Provisional application No. 61/899,261, filed on Nov. 3, 2013.

(51) Int. Cl. G01D 21/02

(52) U.S. Cl. CPC G01D 21/02
USPC 702/189

(57) ABSTRACT

Embodiments discussed herein enable sensor selection based on context and policy to provide for a variety of different sensor types and configurations, and for detecting a variety of different phenomena. In at least some embodiments, a sensor hub is employed to receive requests for sensor data from various functionalities and to select sensors to provide the sensor data based on application of context to policies that specify parameters for sensor selection.

### RELATED APPLICATION

This application claims priority under 35 U.S.C. §119(e) to U.S. Provisional Patent Application No. 61/899,261, entitled “Sensor Fusion for Virtual Sensors” and filed on Nov. 3, 2013, the disclosure of which is incorporated in its entirety by reference herein.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments discussed herein enable sensor selection based on context and policy to provide for a variety of different sensor types and configurations, and for detecting a variety of different phenomena. In at least some embodiments, a sensor hub is employed to receive requests for sensor data from various functionalities and to select sensors to provide the sensor data based on application of context to policies that specify parameters for sensor selection.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates example implementations of sensor recipes in accordance with one or more embodiments.

FIG. 3 illustrates example implementations of policies in accordance with one or more embodiments.

FIG. 4 illustrates an example scenario for generating a wake event in accordance with one or more implementations.

FIG. 5 illustrates an example scenario for determining device location in accordance with one or more implementations.

FIG. 6 illustrates an example scenario for authenticating a user in accordance with one or more implementations.

FIG. 7 is a flow diagram that describes steps in a method for configuring a sensor hub in accordance with one or more embodiments.

FIG. 8 is a flow diagram that describes steps in a method for determining whether to generate a wake event in accordance with one or more embodiments.

FIG. 9 is a flow diagram that describes steps in a method for brokering sensor data in accordance with one or more implementations.

FIG. 10 illustrates an example system and computing device as described with reference to FIG. 1, which are configured to implement embodiments of techniques described herein.

### DETAILED DESCRIPTION

Overview

Many computing devices have multiple sensors that can be employed to sense different types of device-related phenomena. Examples of such sensors include location sensors, orientation sensors, audio sensors, video sensors (e.g., a camera), touch sensors, biometric sensors, climate sensors (e.g., for temperature, pressure, humidity, and so forth), network activity, time and so on. In at least some embodiments, “sensor systems” are defined based on one or more sensors. For instance, an orientation sensor system may include a collection of sensors such as a gyroscope, and accelerometer, and so forth. Data from the different sensors of a sensor system can be processed and/or combined to determine various conditions. Further, input from multiple sensor systems can be considered in determining various conditions, such as device-related conditions, environmental conditions, and so forth.

Embodiments discussed herein enable sensor selection based on context and policy to provide for a variety of different sensor types and configurations, and for detecting a variety of different phenomena. Generally, a sensor hub can be employed to receive sensor input from multiple sensors and to fuse the input in different ways to generate a variety of different sensor types and sensor instances. In at least some embodiments, different sensors can be fused to generate a fused sensor that detects physical phenomena, such as visual input, audio input, touch input, vibrations, movement, and so forth. A fused sensor may also be configured to detect logical phenomena, such as logical state of various processes and/or devices in a system, the occurrence of certain logical events in a system, and so forth.

In at least some implementations, sensor fusion generally includes combining multiple different sensors (e.g., sensor systems) according to sensor “recipes” that specify different combinations of sensors for sensing different phenomena. For instance, multiple sensor recipes can be defined that each specify a different combination of sensors for sensing device position. Another set of sensor recipes can be defined that each specify a different combination of sensors for sensing user identity, such as for authenticating a user for access to various resources. As further detailed herein, sensor recipes can be defined for sensing a variety of different phenomena.

According to various implementations, sensor recipes can be selected based on context and policies for a particular device and/or user. “Context” generally refers to system accessible state that informs a system how to interpret sensor input. Examples of context include user identification, user role (e.g. work roles, personal roles, and so forth), detected behavioral patterns, time, user preferences, environmental information, location, weather, historical values for various context considerations, and so forth. In at least some implementations, system learning may also be employed to generate context information.

Policies may be enforced (e.g., based on context) to select sensors to provide sensor data and to specify how sensor data is used, e.g., which sensor recipe is used to obtain a particular type of sensor data. Generally, sensor policies specify rules and parameters for selection of sensor recipes for providing sensor data. Sensor polices, for instance, can be enforced via application of context in a particular scenario to sensor policies that apply to the scenario. In at least some implementations, sensor policies regulate what system behaviors are allowed or not allowed. Example policy considerations are detailed below.

In at least some implementations, policies may be configured and/or updated explicitly by “policy makers” that are authorized to generate and configure policy. Examples of such policy makers include app developers, operating system developers, information technology (IT) personnel, and so forth. Further, system logic and/or system learning may be employed to suggest and/or make changes to system policy based on monitored system behaviors and/or events. In at least some embodiments, policies are configured to be applied dependent on particular contexts.

According to one or more implementations, a sensor hub and sensor systems provide power isolation with event generation for system power control. For instance, a sensor hub may be implemented in an independent power domain that can be powered on independently from other components of a system, e.g., from a central processing unit (CPU). In at least some implementations, sensor systems may be implemented as isolated sub-systems each with a programmable processor in an independent power domain. Thus, sensor systems may be powered on (e.g., along with a sensor hub) when other components of a system are inactive and/or powered off.

Further to implementations discussed herein, a sensor hub may generate power requests for sensor systems to which it is connected, and may send events to a system-level power control mechanism. For instance, a sensor hub may be powered on and monitor for sensor input while other system components (e.g., a CPU) are inactive. Further, a sensor hub may be configured to generate wake events to wake a CPU and/or graphics processing unit (GPU) in response to sensor input. Wake events may also be generated to wake a system memory controller and related on-chip paths to memory from the sensor hub, and/or to sensor systems that request access to memory and/or processing resources. Various other details and implementations are discussed below.

In the following discussion, an example environment is first described that is operable to employ techniques described herein. Next, a section entitled “Example Scenarios” describes some example operating scenarios in accordance with one or more embodiments. Following this, a section entitled “Example Procedures” describes some example procedures in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Operating Environment

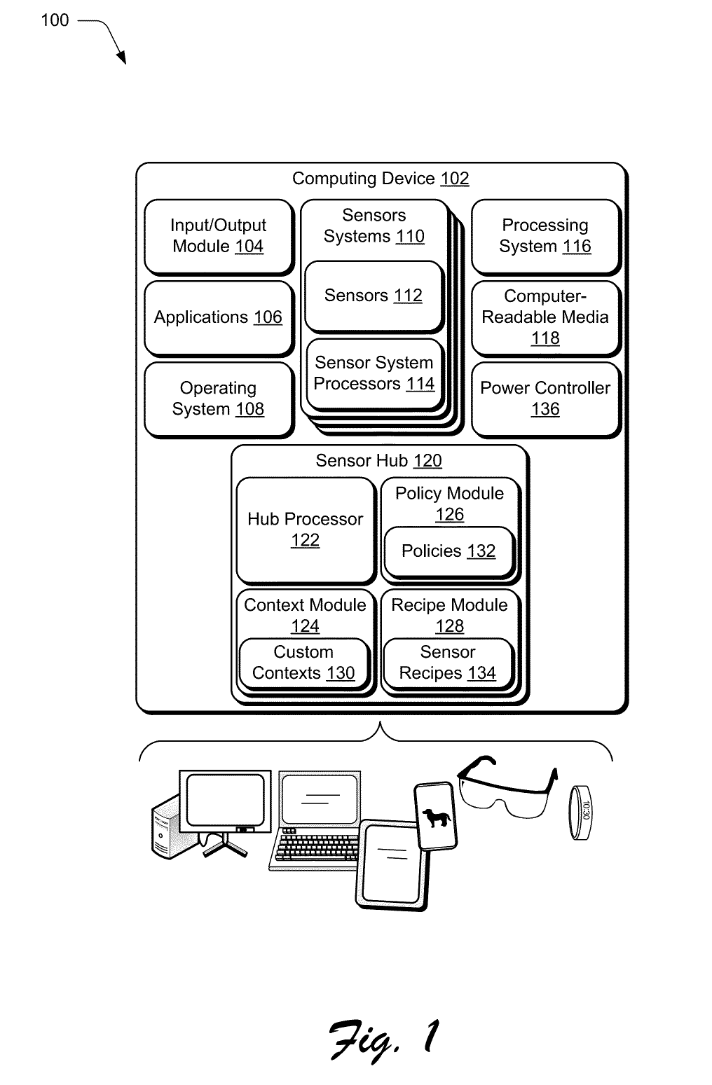

FIG. 1 is an illustration of an environment 100 in an example implementation that is operable to employ techniques for sensor selection based on context and policy described herein. The illustrated environment 100 includes an example of a computing device 102, which may be configured in a variety of ways. For example, the computing device 102 may be configured for mobile use, such as a mobile phone, a tablet computer, a laptop computer, a wearable device, and so on. The computing device 102, for instance, may range from full resource devices with substantial memory and processor resources to a low-resource device with limited memory and/or processing resources.

The computing device 102 includes an input/output module 104, which is representative of functionality relating to processing of inputs and rendering outputs of the computing device 102. A variety of different inputs may be processed by the input/output module 104, such as inputs relating to functions that correspond to keys of an input device, keys of a virtual keyboard displayed by a display device to identify gestures and cause operations to be performed that correspond to the gestures that may be recognized through an accessory device and/or touchscreen functionality of a display device, and so forth. Thus, the input/output module 104 may support a variety of different input techniques by recognizing and leveraging different types of inputs.

As further illustrated in FIG. 1, the computing device 102 includes applications 106 and an operating system 108 that provide different functionality to the device. A variety of applications 106 typically associated with computing devices are contemplated including, but not limited to, a productivity suite that integrates multiple office productivity modules, a web browser, games, a multi-media player, a word processor, a spreadsheet program, a photo manager, and so forth. The operating system 108 is representative of functionality to abstract and manage various resources of the computing device, such as hardware resources, software resources, processes, services, and so forth.

Multiple sensor systems 110 are installed on and/or operably associated with the computing device 102. Generally, the sensor systems 110 are configured to sense various phenomena relative to the computing device 102. The individual sensor systems 110 include one or multiple types and instances of sensors 112. Examples of the sensors 112 include an accelerometer, a camera, a microphone, biometric sensors, touch input sensors, position sensors, environmental sensors (e.g., for temperature, pressure, humidity, and so on), and so forth. One or more of the sensors 112 may be configured to detect other types of phenomena, such as time (e.g., internal and/or external time), various types of device state, logic state, process state (e.g., application state), and so forth. In at least some implementations, a sensor 112 may represent stored data that can be used as part of a recipe. For instance, a Boolean value can be used to represent sensor data (e.g., as a virtual sensor) that can be leveraged as part of a sensor recipe. The sensors 112 may include a variety of other types and instances of sensors not expressly mentioned herein.

The sensor systems 110 may be individually associated with different types of phenomena. For instance, a particular sensor system 110 may be configured to sense image input, such as via cameras and/or other types of light sensors. Another sensor system 110 may be configured to detect audio input, such as via microphone. Still another sensor system 110 may be configured to detect various internal state attributes of the computing device 102, such as process state, logic state, application state, hardware state, and so forth. Thus, the sensor systems 110 may combine to provide an array of sensing capabilities for the computing device 102.

In accordance with techniques described herein, sensor data obtained by and/or from the sensor systems 110 may be processed and/or combined in a variety of ways according to embodiments discussed herein. For instance, sensor data streams from the different sensor systems 110 can be fused in various ways to provide for a multitude of different sensor configurations and behaviors.

The sensor systems 110 further include sensor system processors 114, which are representative of data processing units for the sensor systems. For instance, in at least some implementations, an individual sensor system 110 includes a respective sensor system processor 114 that provides data processing, caching, and programmability to the sensor system 110.

The computing device 102 further includes a processing system 116 and computer-readable media 118, which are representative of various different types and combinations of processing components, media, memory, and storage components and/or devices that may be associated with the computing device 102 and employed to provide a wide range of device functionality. In at least some embodiments, the processing system 116 and computer-readable media 118 represent processing power and memory/storage that may be employed for general purpose computing operations. According to one or more implementations, the processing system 116 represents a central processing unit (CPU) of the computing device 102.

The computing device 102 further includes a sensor hub 120, which is representative of functionality to perform various aspects of techniques for sensor selection based on context and policy discussed herein. The sensor hub 120 may be implemented in various ways, such as via a standalone environment that may operate independent of other functionalities of the computing device 102. For instance, in one or more implementations the sensor hub 120 may be implemented via on-chip systems/circuits (e.g., as part of a system on a chip (SoC)) having self-contained resources such as processing components, various types of memory, programmable logic, and so forth. The sensor hub 120, for example, enables various aspects of techniques for sensor selection based on context and policy discussed herein to be performed outside of general operation of the computing device 102.

According to various implementations, the sensor hub 120 represents an abstraction layer of logic between the sensor systems 110 and other functionalities of the computing device 102, e.g., the operating system 108, and applications 106, and so forth. For instance, the sensor hub 120 may process requests from different functionalities for sensor data and select one or more of the sensor systems 110 to provide the sensor data utilizing logic that is internal to the sensor hub 120. Thus, various implementations enable a functionality to request a particular type of sensor data from the sensor hub 120 and to receive a data stream of the particular type of sensor data, without the functionality being involved in selection of a specific sensor system 110 to provide the stream of sensor data. The sensor hub 120, for instance, may appear to other functionalities of the computing device 102 as a single sensor representation to which requests for different types of sensor data are to be submitted and from which streams of different types of sensor data are received.

In at least some implementations, the sensor hub 120 may be powered independently from other components of the computing device 102, e.g., via an independent power domain. For instance, the sensor hub 120 may remain powered on while other components of the computing device 102 (such as the processing system 116) are in a low power mode, e.g., hibernated and/or powered off Thus, one or more implementations enable aspects of sensor selection based on context and policy to be performed while the computing device 102 is in a low power mode and/or powered off.

Accordingly, the sensor hub 120 also represents an independent logic domain that may execute various processes related to techniques for sensor selection based on context and policy discussed herein independent of interaction with external system components such as the processing system 116, the operating system 108, and so forth. Examples of such logic and processes are presented below.

The sensor hub 120 includes a hub processor 122, a context module 124, a policy module 126, and a recipe module 128. The hub processor 122 is representative of a processing unit of the sensor hub 120, and may perform storage and/or execution of various logic discussed herein.

The context module 124 is representative of functionality to interpret and/or process different state conditions that pertain to requests for sensor data and/or sensor-related behaviors. Examples of context information are detailed elsewhere herein. In at least some implementations, context may be programmatically defined such that custom contexts 130 can be specified based on various detected state conditions. The context module 124 may include logic for interpreting raw state information and for correlating specific sets of environmental conditions to custom contexts 130. In at least some implementations, context information may be include information that is stored, information that is streamed to and/or from the computing device 102, as well is information that is observed, e.g., environmental state information.

The policy module 126 is representative of functionality to store, manage, and configure policies 132. Generally, the policies 132 specify different rules and parameters for implementing techniques for sensor selection based on context and policy. While certain of the policies 132 may be sensor-specific, the policies 132 may additionally or alternatively represent general policies that govern local and/or global system behaviors and that may be applied to sensor behaviors as well. In at least some implementations, the policy module 126 can cause a GUI to be presented that enables user configuration of the policies 132. Further details concerning policies are discussed below.

The recipe module 128 is representative of functionality to store, manage, and configure sensor recipes 134. Generally, the sensor recipes 134 specify different instances and combinations of sensors for sensing different phenomena. In at least some implementations, individual sensor recipes 134 can include sensors from different sensor systems 110. Thus, the sensor recipes 134 enable fusion of sensors from multiple sensor systems 110 to create custom combinations of sensors that may sense and/or detect various types of phenomena. Based on the policies 132, for instance, different of the sensor recipes 134 can be selected for sensing different phenomena. According to one or more implementations, the sensor hub 120 can cause a graphical user interface (GUI) to be presented that enables user configuration of the sensor recipes 134. Further details concerning recipes are discussed below.

The computing device 102 further includes a power controller 136, which is representative of functionality to perform power management for different functionalities of the computing device 102. The power controller 136, for instance, may enable various functionalities of the computing device 102 to transition between different activity states, such as between normal operational modes, hibernation modes, power-off modes, and so forth. As detailed herein, the sensor hub 120 may receive sensor data from the sensor systems 110, and based on the sensor data, may prompt the power controller 136 to transition different functionalities of the computing device 102 between different power states.

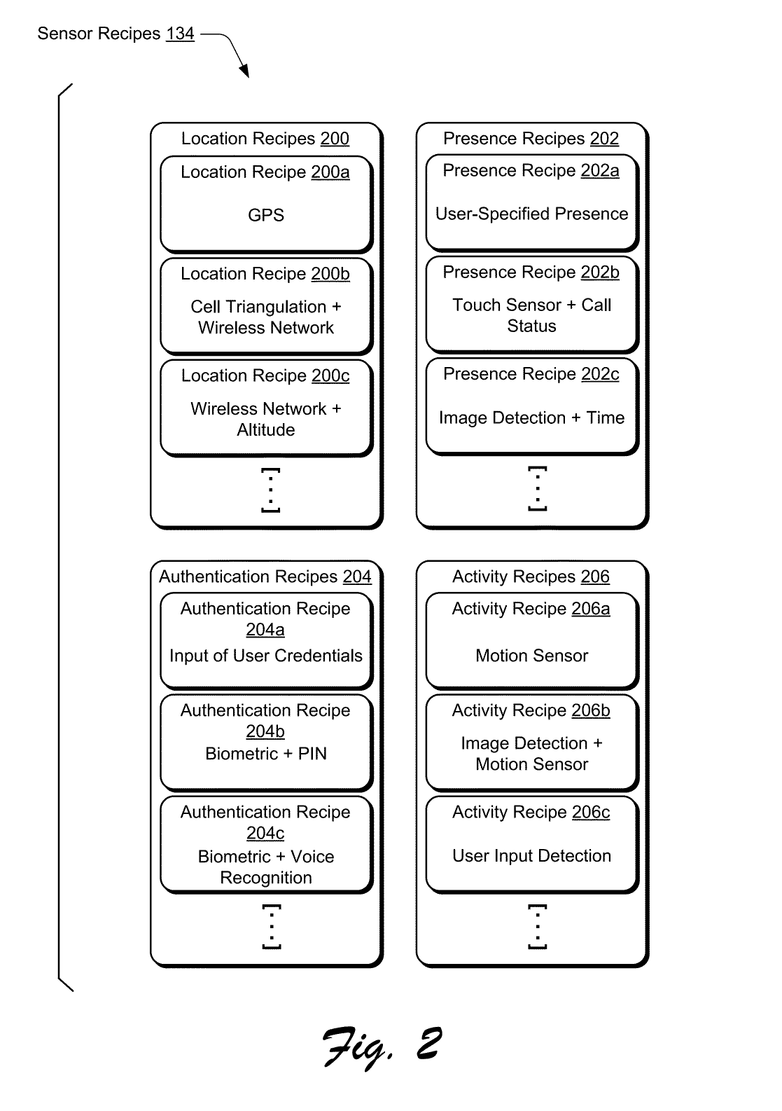

FIG. 2 illustrates an example implementation of the sensor recipes 134 in accordance with one or more embodiments. Generally, the sensor recipes 134 specify different instances, types, and/or combinations of sensors that can be employed to sense different phenomena.

Location recipes 200 specify different instances and combinations of sensors that can be employed to detect location, e.g., location of the computing device 102 and/or a user of the computing device. For instance, a location recipe 200a specifies that GPS coordinates may be utilized to detect a location of a user, such as based on GPS coordinates detected by the user's device. A location recipe 200b specifies that cell phone triangulation and wireless network information may be utilized to detect a location of a user. A location recipe 200c specifies that wireless network information plus altitude detection information may be utilized to detect a location of a user.

Presence recipes 202 specify different instances and combinations of sensors that can be employed to detect user presence. Examples of user presence include “available,” “busy,” “in a meeting,” “on a call,” “away,” “office,” and so forth. Thus, a presence recipe 202 can be utilized to detect a presence status of a user. A presence recipe 202a specifies that user-specified presence information may be utilized to determine a user's presence status. Examples of user-specified presence information include status information set by a user, such as on an online chat service, a social media platform, a Voice over Internet Protocol (VoIP) service, and so forth.

A presence recipe 202b specifies that touch sensor input plus call status may be utilized to determine a presence status of a user. For instance, if a touch input device detects that a user is holding their mobile device but cell phone functionality does not detect that a call is in progress, a user may be determined to be available. On the other hand, if a cell call is detected to be in progress, a user may be determined to be “busy” and/or “on a call.” A presence recipe 202c specifies that image detection plus time of day may be utilized to determine user presence. For instance, a camera and/or cameras may be activated to detect whether the user is detectable, e.g., is within a viewing area of the cameras. If the user is detected by the camera and the time of day is during normal business hours, the user may be determined to be “available.” Otherwise, if the user is not detected by the camera and/or if the user is detected but the time of day is after business hours, the user may be determined to be “away.”

Authentication recipes 204 specify different instances and combinations of sensors that can be employed to authenticate the identity of a user, such as for access to unlock a computing device and/or to enable access to protected resources. An authentication recipe 204a specifies that input of user credentials may be used to authenticate a user. Examples of user credentials include a username, a password, a personal identification number (PIN), and so forth.

An authentication recipe 204b specifies that biometric authentication plus input of a personal identification number (PIN) may be utilized to authenticate a user. Examples of biometric authentication include fingerprint matching, facial recognition, ocular recognition, and so forth. An authentication recipe 204c specifies that biometric plus voice recognition may be utilized to authenticate a user.

Activity recipes 206 specify different instances and combinations of sensors that can be employed to detect a type of activity that a user is engaged in. An activity recipe 206a specifies that a motion sensor may be utilized to detect user activity. For instance, if a user is moving quickly and running motion is detected, a user may be determined to be exercising, e.g., running If a user is moving quickly but little non-translational motion is detected, a user may be determined to be in transit, e.g., driving.

An activity recipe 206b specifies that image detection plus motion sensing may be used to detect user activity. For instance, if a user's image is detected but little or no motion is detected, a user may be determined to be home or at work. An activity recipe 206c specifies that user input detection can be utilized to detect user activity. For instance, a type of user input that a user is providing can be analyzed. If a user is providing input to a work-related document, the user can be determined to be working. If a user is reading a social media site, a user may be determined to be engaged in a leisure activity.

Thus, different types and instances of sensors may be specified via recipes to sense different types of phenomena. According to various implementations, individual sensor recipes 134 may be considered virtual sensors that may be implemented to detect phenomena. For instance, although a particular sensor recipe 134 may specify multiple instances of sensors from different sensor systems, the recipe may simply appear to other functionalities (e.g., the operating system 108) as an instance of a sensor that may be called to sense different phenomena. These particular types and instances of recipes are presented for purpose of example only, and it is to be appreciated that implementations may utilize different types and instances of recipes not expressly discussed herein.

In at least some implementations, a sensor recipe 134 may include data that indicates how sensor data from various sensors specified in the recipe is to be interpreted and/or fused. Thus, a sensor recipe may not only include a particular sensor or collection of sensors, but may also include logic for processing raw sensor input to obtain complex environment information. Implementations may thus enable sensors from different sensor systems to be fused via a sensor recipe 134 into an integrated “virtual sensor” that can provide sensor data across multiple sensor domains. Further, multiple different virtual sensors may be defined via different sensor recipes that coalesce sensor data streams from different sensor systems 110 into coherent data streams for consumption by various functionalities.

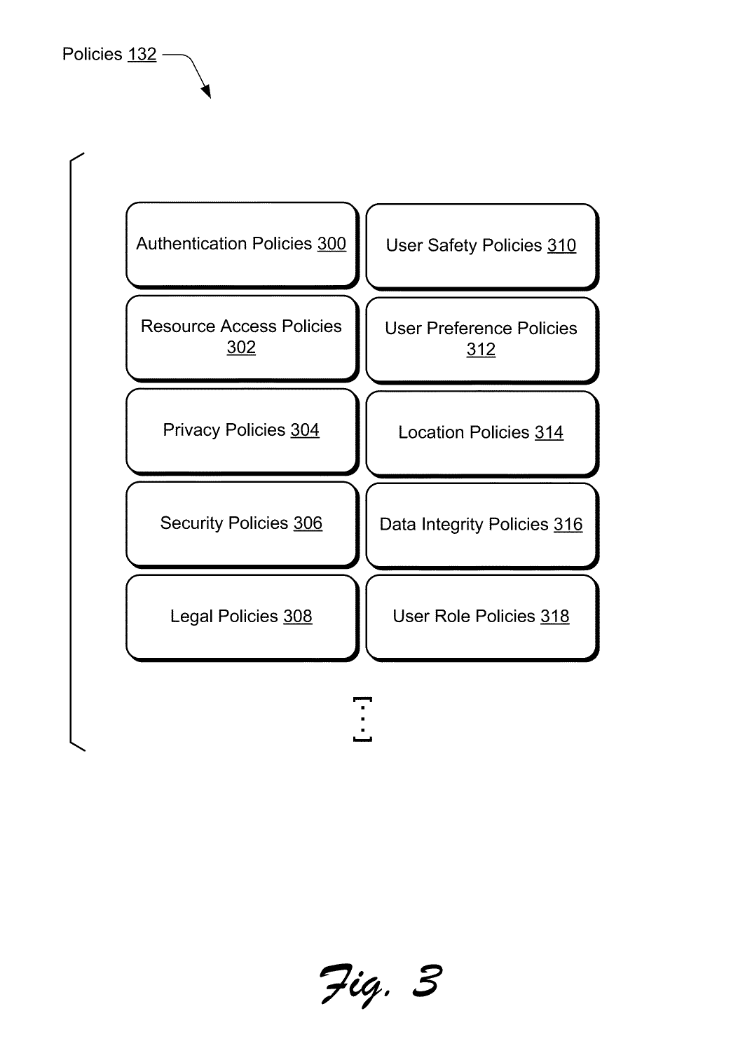

FIG. 3 illustrates example implementations of the policies 132 in accordance with one or more embodiments. Generally, the policies 132 represent different types and instances of policies that can be employed to select various sensors and sensor recipes 134 for sensing different phenomena. In at least some implementations, one or more of the policies 132 may be defined by an enterprise entity, a government entity, an end-user, and so forth. The polices 132 may be specific to sensor scenarios and/or may represent general policies that apply to general institutional and individual behaviors including but not limited to sensor-related behaviors.

Authentication policies 300 specify rules and parameters for authentication procedures under different contexts. For instance, authentication policies 300 may specify which authentication procedures are allowed and which are not allowed in different contexts.

Resource access policies 302 specify rules and parameters for determining which types of resources may be accessed, who may access particular resources, and conditions under which particular resources may be accessed. Examples of resources include data resources (e.g., content, files, and so on), hardware resources (e.g., computing devices, output devices, communication devices, and so on), network resources (e.g., network connections), physical resources (e.g., meeting rooms, offices, and so on), personnel resources, and so forth.

Privacy policies 304 specify rules and parameters for protecting privacy concerns. For instance, the privacy policies 304 may be implemented to protect user privacy, enterprise privacy, data privacy, and so forth.

Security policies 306 specify rules and parameters for protecting resource security. Security policies 306, for instance, may specify rules and parameters that govern who may access particular resources, and how the resources may be accessed.

Legal policies 308 specify rules and parameters that are based on legal considerations. For example, the legal policies 308 may be enforced to ensure that sensor use does not violate law in a particular jurisdiction.

User safety policies 310 specify rules and parameters that may be implemented to protect user safety. User safety policies 310, for example, may specify types of sensors that may or may not be used in certain scenarios to prevent possible unsafe behaviors or conditions.

User preference policies 312 specify rules and parameters for sensor use that are based on user preferences. According to various implementations, user preferences may be expressly indicated by a user and/or may be inferred from user behavior.

Location policies 314 specify rules and parameters for selecting and employing sensors for determining user and/or device location. Location policies 314, for instance, may specify types of sensor input and/or information that may employed to ascertain user and/or device location. In at least some implementations, the location policies 314 can consider other policies in specifying rules and parameters for determining user and/or device location, such as in the interest of protecting security, privacy, legal considerations, and so forth.

Data Integrity Policies 316 specify rules and parameters for ascertaining whether and/or how to utilize sensor data that does not meet certain standards for data integrity. Data integrity standards, for instance, may specify an allowed number of errors in sensor data, a minimum data rate from a sensor, allowed and/or disallowed data types of a particular sensor, and so forth. For example, a data integrity policy 316 may specify that if sensor data from a particular sensor does not meet a data integrity standard (e.g., the data has too many errors and/or is not in the right form or format), the sensor data is not to be used. Thus, a recipe that utilizes the particular sensor may be ignored. Further, if a particular sensor fails while being used to provide sensor data, a different sensor recipe that does not include the sensor can be selected, e.g., dynamically. Thus, the data integrity policies 316 may provide ways for enforcing sensor data standards in terms of quality and form of sensor data.

User Role Policies 318 specify rules and parameters for selecting sensor recipes based on different roles for users. For instance, users may have different roles, such as administrators, users, guests, and so forth. Further, a particular user may assume different roles depending on where the user is located at a given time and/or in what capacity the user is acting at a given time. For instance, when a user is at home the user may be considered to be acting in a “consumer role” whereas when the user is at work the user may be considered to be acting in an “enterprise role.” In at least some implementations, different roles may be differentiated by different permissions and/or user attributes. Thus, the user role policies 318 may specify particular types and/or instances of sensors that may be used for particular user roles, and may also specify different types and/or instances of sensors that may not be used for particular user roles. In at least some implementations, the user role policies 318 may be applied on a particular system based on a user account that is currently active on the system, e.g., a user that is logged into the system.

Thus, different policies may be employed to select particular recipes for sensing different phenomena. Policies may be combined and/or customized to suit different scenarios and/or environments. These particular types and instances of policies are presented for purpose of example only, and it is to be appreciated that a wide variety of policies not expressly mentioned herein may be implemented in accordance with one or more implementations.

Having discussed an example environment in which embodiments may operate, consider now some example implementation scenarios that utilize techniques discussed herein in accordance with one or more embodiments.

Example Scenarios

The following discussion describes some example scenarios for sensor selection based on context and policy techniques that may be implemented utilizing the previously described systems and devices and/or other systems and devices not expressly discussed herein. Aspects of the scenarios may be implemented in hardware, firmware, software, or combinations thereof.

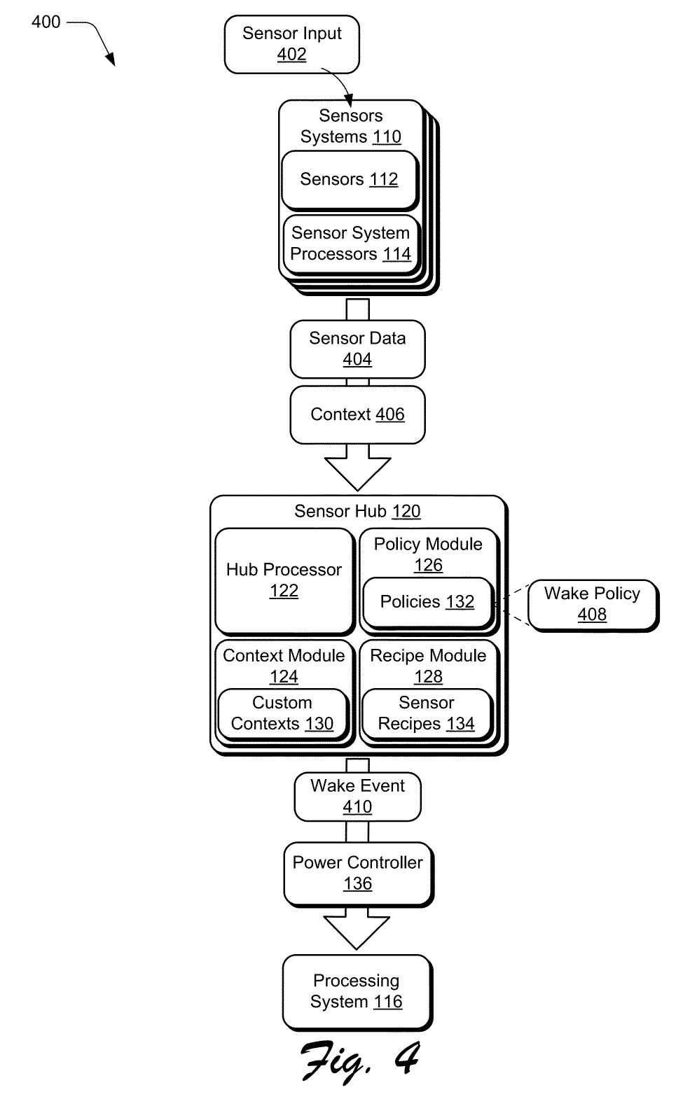

FIG. 4 illustrates an example operating scenario 400 for generating a wake event in accordance with one or more implementations. The scenario 400 includes various components of the computing device 102 introduced above, such as the sensor systems 110, the sensor hub 120, the processing system 116, and the power controller 136. According to the scenario 400, the processing system 116 is initially in an inactive and/or low power state, such as an off state or a hibernated state. The sensor system 110 and the sensor hub 120, however, are in an active state.

In the scenario 400, sensor input 402 is provided to the sensor system 110, such as via a particular type of phenomena sensed by one or more of the sensors 112. The sensor input 402 may include active input, e.g., as user input to an input device such as a touchscreen, a keyboard, and so forth. Alternatively or additionally, the sensor input 402 may include passive input, such as various detected incidental phenomena. Passive input may include detection of user presence, such as detecting a user's image via a camera, detecting a user's voice, and so forth. Passive input may also include various changes in system and/or environmental state, such as occurrence of a particular clock time, occurrence of a certain application and/or process state, detection of certain physical phenomena (e.g., light level, temperature, and so forth), and so on.

Based on the sensor input 402, the sensor system 110 communicates sensor data 404 to the sensor hub 120. The sensor data 404 may include raw sensor data generated in response to the sensor input 402 and/or sensor input that results from processing applied by the sensor system 110 to the sensor input 402. The sensor hub 120 processes the sensor data 404 based on context 406 pertaining to the sensor input 402 as applied to one or more of the policies 132. Generally, the context 406 generally describes state conditions (e.g., environment and/or system state) that surround input of the sensor input 402. For instance, the context 406 may indicate a current state condition of the computing device 102, e.g., that the processing system 116 is in an inactive state. The context 406 may indicate various other state information, such as time of day, location, calendar events, and so forth.

According to one or more implementations, the policies 132 specify rules and parameters for interpreting and/or processing sensor input under different contexts. In the example scenario 400, the policies 132 include a wake policy 408 that specifies rules and parameters for generating wake events in response to sensor input. Generally, “wake events” refer to notification and/or power events that can cause different functionalities to transition from an inactive state to an active state. The wake policy 408, for instance, may specify combinations of contexts and sensor inputs that may cause a wake event to be generated, and/or combinations of contexts and sensor inputs that do not result in a wake event being generated.

Continuing with the scenario 400, the wake policy 408 specifies that based on the type of the sensor data 404 and the context 406 in which the sensor data 404 is received, a wake event is to be generated. Thus, the hub processor 122 generates a wake event 410. The sensor hub 120 then communicates the wake event 410 to the power controller 136. In response to receiving the wake event 136, the power controller 136 causes the processing system 116 to transition to an active state, such as a normal operating power state. The processing system 116 may then initiate various processes, such as initiating a system boot process, waking other functionalities of the computing device 102, and so forth.

While the scenario 400 illustrates the wake event 410 causing the processing system 116 to transition between activity states, it is to be appreciated that the wake event 410 may additionally or alternatively be communicated to other functionalities to enable the functionalities to transition between activity states.

Thus, the scenario 400 illustrates that in various implementations, sensor input can be received and processed according to context and policy by the sensor hub 120 while other components of a system (e.g., a CPU, a GPU, and so forth) are not active. This enables decisions to be made concerning how to process sensor input and whether to generate certain events based on sensor input independent of primary processing apparatus of a system, thus enabling system power and resources to be conserved.

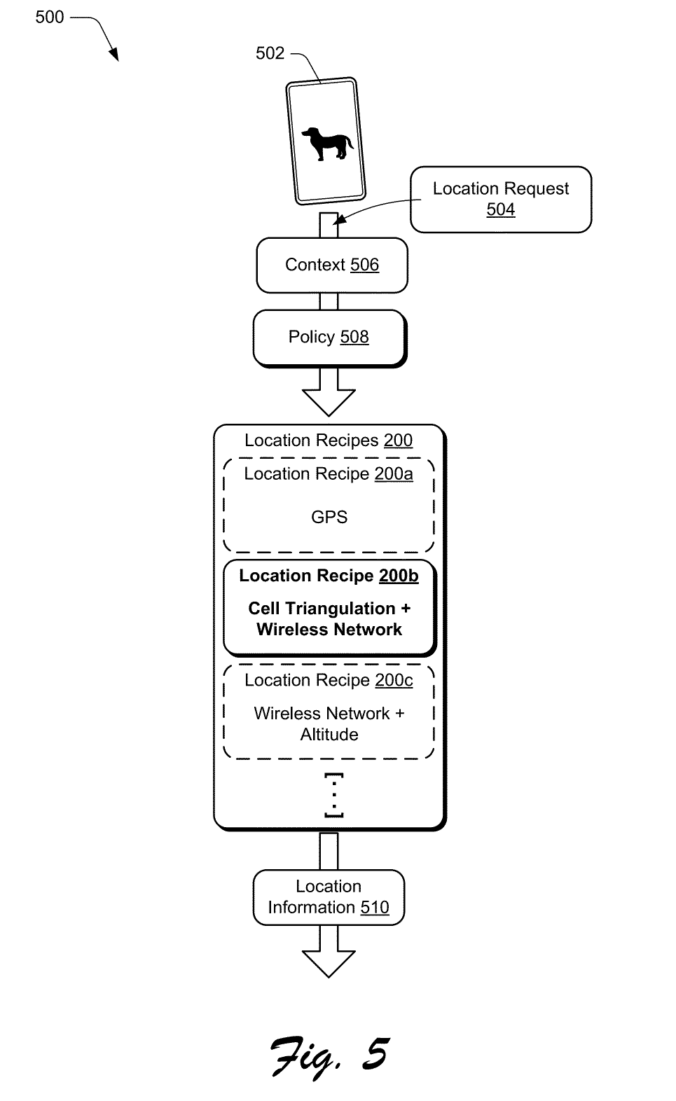

FIG. 5 illustrates an example operating scenario 500 for determining device location in accordance with one or more implementations. In at least some implementations, the scenario 500 represents a continuation of the scenario 400 discussed above. The scenario 500 includes a device 502, which represents an implementation of the computing device 102 in accordance with one or more implementations.

In the scenario 500, a location request 504 for a location of the device 502 is initiated. The location request 504 may be initiated internally to the device 502, such as by an application and/or service associated with the device 502. Alternatively or additionally, the location request 504 may be initiated externally to the device 502.

In response to the location request 504, a context 506 is determined for the location request 504. The context 506 generally includes different state conditions that exist in relation to the location request 504. In at least some implementations, the context 506 may be specific to the device 502, such as internal state information for the device 502, state conditions that are detected via sensors of the device 502, identification information for the device 502 (e.g., device and/or user identifiers), and so forth. The context 506 may additionally or alternatively include conditions under which the location request 504 is initiated, such as an identifier for an entity that initiated the request 504, a time and/or day on which the request 504 is initiated, user preferences for location requests, and so forth. Thus, in at least some implementations, the context 506 may include a variety of different instances and types of state information that may be considered in processing the location request 504. In this particular example, the context 506 indicates that the device 502 has poor GPS signal reception. The device 502, for example, may be indoors and/or at a location where GPS signal from GPS satellites is partially or wholly blocked.

Continuing with the scenario 500, the context 506 is applied to a policy 508 to determine a sensor recipe to employ to determine a location of the device 502. The policy 508 may include various types and/or instances of policies. For example, the policy 508 may represent implementations of one or more of the policies 132, examples of which are discussed above with reference to FIG. 3. In the scenario 500, the policy 508 specifies that if the device 502 has poor GPS reception and/or no GPS reception, a location recipe that does not involve GPS signal is to be selected for determining location. Thus, based on the context 506 as applied to the policy 508, a location recipe 200b of the location recipes 200 is selected. As illustrated, the location recipe 200b does not include GPS, and thus complies with the policy 508.

Accordingly, location information 510 for the device 502 is determined using cell triangulation and wireless network information as specified by the location recipe 200b. For instance, cellular functionality of the device 502 interacts with cellular base stations to ascertain cell-based location information for the device 502. Further, network location information is determined based on a wireless and/or wired network (e.g., a broadband network) to which the device 502 is connected. The location information 510 is processed to estimate a location of the device 502. The estimated location is returned in response to the location request 504, such as to functionality of the device 502 and/or other requesting entity.

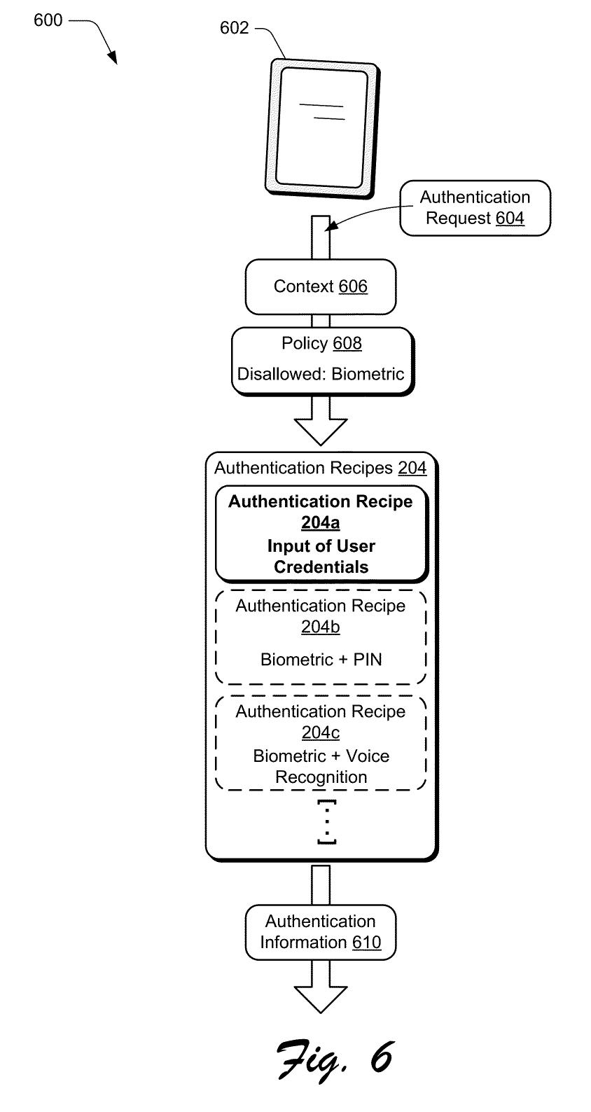

FIG. 6 illustrates an example operating scenario 600 for authenticating a user in accordance with one or more implementations. The scenario 600 includes a device 602, which represents an implementation of the computing device 102 in accordance with one or more implementations. In at least some implementations, the scenario 600 may represent an extension of the scenario 400 and/or scenario 500, discussed above.

In the scenario 600, an authentication request 604 is initiated, such as by functionality of the device 602 and/or functionality external to the device 602. In this particular example, the authentication request 604 is initiated to authenticate a user for access to a protected resource, such as an enterprise email account, protected content, and so forth.

In response to the authentication request 604, a context 606 is determined. Examples of different context considerations are discussed elsewhere herein. Generally, the context 606 includes state information that pertains to the authentication request 604. According to the scenario 600, the context 606 indicates that the authentication request 604 is based on a request for access to a protected enterprise resource.

Continuing with the scenario 600, the context 606 is applied to a policy 608 to ascertain a sensor recipe to be employed for an authentication procedure. With regard to authentication, for instance, a sensor can refer to a variety of different functionalities for inputting and/or receiving authentication information. The policy 608 may include various types and/or instances of policies. For example, the policy 608 may represent implementations of one or more of the policies 132 (e.g., the authentication policies 300) discussed above with reference to FIG. 3.

In the scenario 600, the policy 608 specifies one or more types and/or instances of sensors that are not permitted to be used for authentication purposes for access to protected enterprise resources. The policy 608, for instance, specifies that a biometric sensor is not recognized as a valid authentication sensor for enterprise authentication. For example, an enterprise entity may determine that certain biometric sensors are easily spoofed, and thus are not to be trusted for authentication for access to protected enterprise resources. Thus, based on the context 606 as applied to the policy 608, an authentication recipe 204a of the authentication recipes 204 is selected. As illustrated, the authentication recipe 204a does not include biometric sensors, and thus complies with the policy 608. Since the authentication recipes 204b, 204c include biometric sensors, the authentication recipes 204b, 204c do not comply with the policy 608 and thus are not presented as available options for the authentication request 604. Accordingly, in at least some implementations, policies may be employed as filters that cause non-complying recipes and/or sensors to be excluded when identifying sensors in response to a request for sensor data.

Continuing with the scenario 600, authentication information 610 is collected utilizing sensors identified by the authentication recipe 204a. For instance, a user is prompted to provide user credentials to the device 602. User credentials may be provided in a variety of ways, such as via touch and/or keyboard input of a username, a password, an authentication pattern (e.g., image-based pattern) and/or other type of user credential. If the authentication information 610 matches a user profile that is permitted access to the protected resource, the user may be permitted access to the resource.

These example scenarios are presented for purpose of example only, and it is to be appreciated that techniques discussed herein may be employed in a wide variety of other scenarios not expressly illustrated or discussed. Having described some example scenarios according to techniques described herein, consider now a discussion of some example procedures in accordance with one or more implementations.

Example Procedures

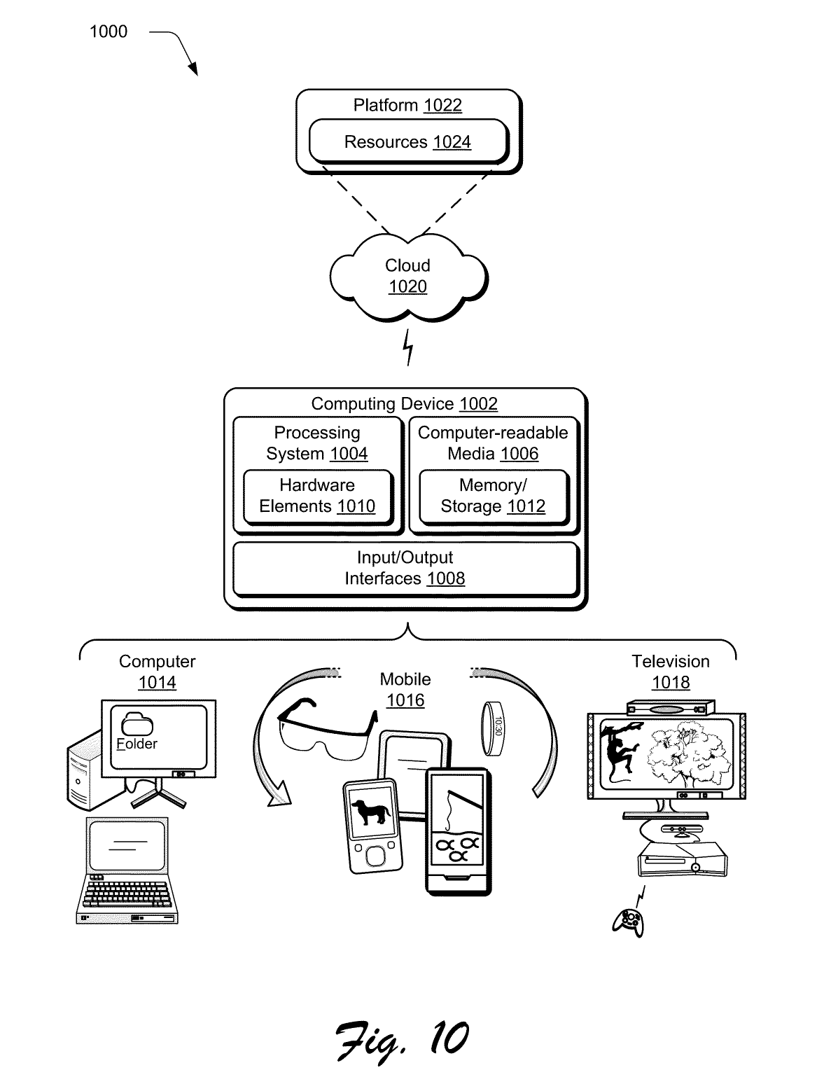

The following section describes some example procedures for sensor selection based on context and policy in accordance with one or more embodiments. The example procedures may be employed in the environment 100 of FIG. 1, the system 1000 of FIG. 10, and/or any other suitable environment. In at least some embodiments, steps described for the various procedures are implemented automatically and independent of user interaction.

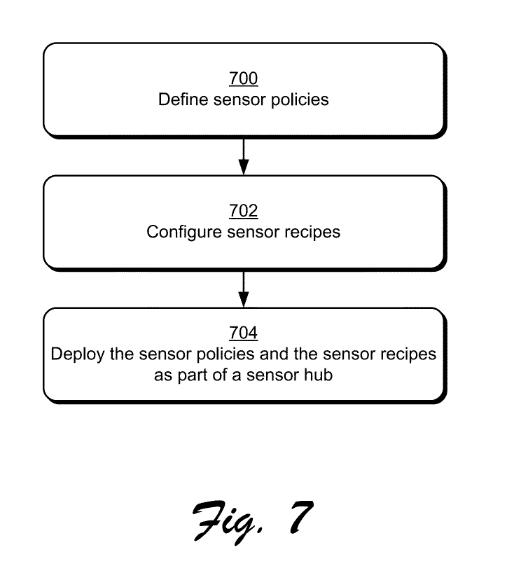

FIG. 7 is a flow diagram that describes steps in a method in accordance with one or more embodiments. The method, for instance, describes an example way of configuring a sensor hub in accordance with one or more implementations.

Step 700 defines sensor policies. The sensor policies, for instance, are defined based on different contexts and for different types, instances, and combinations of sensors. In at least some embodiments, the sensor policies can be defined in response to user input of specific policy parameters. Alternatively or additionally, sensor policies may be defined based on parameters that are inferred, such as from user preferences, system behaviors, environment attributes, and so forth. While sensor policies may be sensor specific, sensor policies may alternatively or additionally be based on general policies that also apply to systems and behaviors outside of sensor-based considerations.

Step 702 configures sensor recipes. As detailed elsewhere herein, sensor recipes specify different types, instances, and/or combinations of sensors. A recipe, for instance, may include a single sensor or a combination of multiple sensors. As used herein, the term “sensor” is to be broadly interpreted as including any functionality that can detect different phenomena, such as physical phenomena, system state phenomena, logical state, and so forth.

According to various implementations, individual recipes are configured to detect specific types of phenomena. Further, multiple different recipes may be defined for detecting a particular type of phenomena. For instance, multiple light detection recipes can be defined that each include a different type and/or combination of light sensors for sensing light-related phenomena.

Sensor recipes can be configured and reconfigured based on changes to sensor configuration. For instance, if a new sensor is installed on a device, the sensor can be added to an existing recipe. Alternatively or additionally, a new recipe can be defined for the sensor. According to various implementations, the configuration and reconfiguration of sensor recipes can be invisible to a functionality that requests sensor data, such as an operating system. For instance, recipes can be configured and reconfigured via configuration of a sensor hub and independent of an operating system.

Step 704 deploys the sensor policies and the sensor recipes as part of a sensor hub. The sensor hub, for instance, can receive requests for sensor input and can select recipes for providing the sensor input based on context of the requests as applied to the sensor policies.

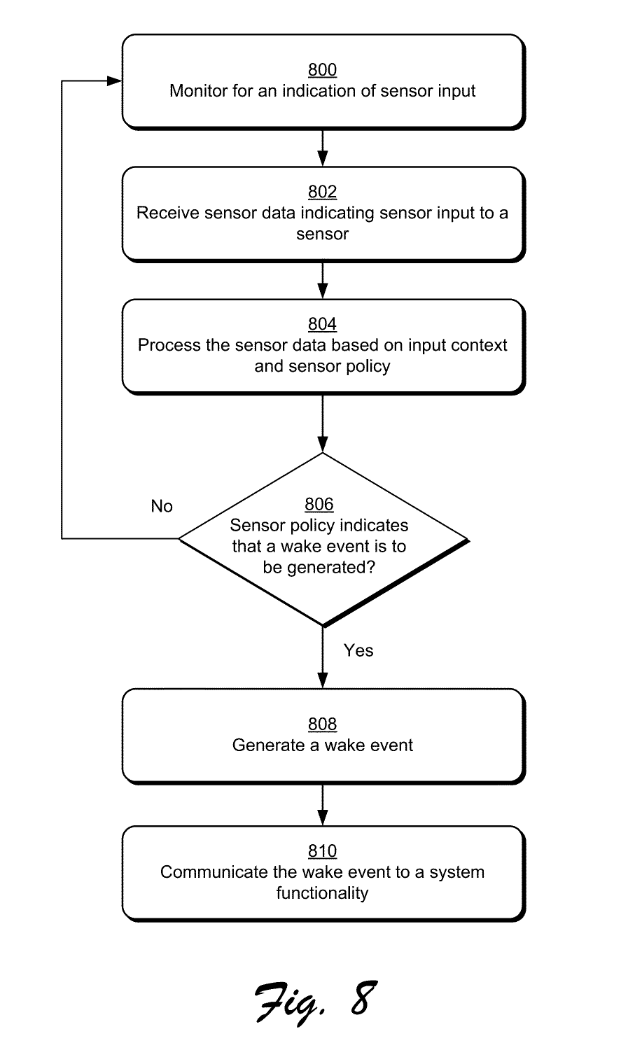

FIG. 8 is a flow diagram that describes steps in a method in accordance with one or more embodiments. The method, for instance, describes an example way of determining whether to generate a wake event in accordance with one or more implementations. In at least some implementations, the method is an extension of the method described above with reference to FIG. 7.

Step 800 monitors for an indication of sensor input. For example, the sensor hub 120 persists in an active state that enables the sensor hub 120 to receive sensor data indicating sensor input. In at least some implementations, the sensor hub 120 persists in an active state while other components of a system (e.g., a CPU) are in an inactive state.

Step 802 receives sensor data indicating sensor input to a sensor. The sensor hub 120, for instance, receives sensor data from a sensor system 110 indicating that sensor input is provided to a sensor 112 of the sensor system 110. In at least some implementations, the sensor data is received while a system is in a low power mode, e.g., while a CPU and/or GPU are powered off or hibernated.

Step 804 processes the sensor data based on input context and sensor policy. For example, the sensor hub 120 ascertains a context associated with the sensor input, such as state conditions that pertain to the sensor input. The sensor hub 120 applies the sensor data (e.g., the type of sensor input) and its context to a sensor policy. In at least some implementations, the sensor policy includes a wake policy that is applied while a system is in an inactive state.

Step 806 ascertains whether the sensor policy indicates that a wake event is to be generated. The sensor hub 120, for example, evaluates rules and/or parameters of the sensor policy based on the sensor data and context to determine whether the sensor policy indicates that based on the sensor data and context, a wake event is to be generated. For instance, the sensor policy may specify particular types of sensor input that may result in a wake event (e.g., touch input), and particular types of sensor input that do not result in a wake event, e.g., accelerometer input alone. The sensor policy may also specify a context under which a particular type of sensor input is to generate a wake event and a context under which the type of sensor input does not generate a wake event. Thus, in some contexts a particular type of sensor input may cause a wake event to be generated, while in other contexts the type of sensor input may not cause a wake event to be generated.

If the sensor policy indicates that a wake event to be generated (“Yes”), step 808 generates a wake event. The sensor hub 120, for instance, generates a wake notification that indicates that a system is to transition to a normal operating mode. Step 810 communicates the wake event to a system functionality. For example, the sensor hub 120 transmits the wake event to a power controller such that a CPU and/or other functionality is transitioned from an inactive state to an active state.

If the sensor policy indicates that a wake event is not to be generated (“No”), the method returns to step 800. The sensor hub 120, for example, does not generate wake event in response to the sensor input, and continues to monitor for additional sensor input.

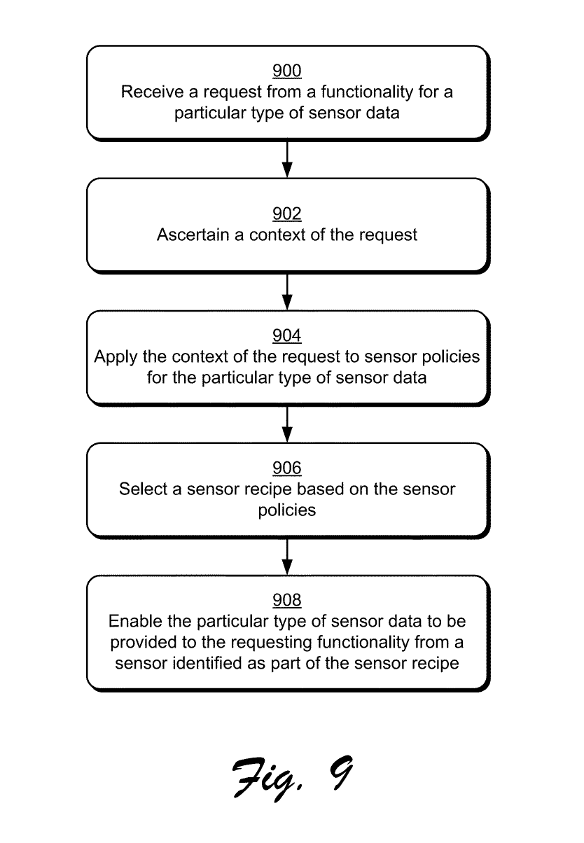

FIG. 9 is a flow diagram that describes steps in a method in accordance with one or more embodiments. The method, for instance, describes an example way of brokering sensor data in accordance with one or more implementations. In at least some implementations, the method is an extension of the method(s) described above with reference to FIGS. 7 and/or 8.

Step 900 receives a request from a functionality for a particular type of sensor data. The sensor hub 120, for example, receives a request from a functionality for sensor data of a particular type. Examples of a functionality that may request sensor data include a processing functionality (e.g., a CPU, a GPU, and so forth), an operating system, an application, a service, a device, and so on.

Step 902 ascertains a context of the request. As discussed herein, context generally refers to various state conditions that pertain to sensor input and/or requests for sensor input. State conditions may refer to environmental state, device state, logic state, and so forth. In at least some implementations, the context may include an identity and/or type for the requesting functionality. Context information, for example, may be included as part of a request for sensor data.

Context may change over time, such as in response to changes in state and/or environments conditions. Thus, according to various implementations, changes in context may result in different recipes being selected when dynamic context is applied to a particular policy or set of policies.

Step 904 applies the context of the request to sensor policies for the particular type of sensor data. As detailed herein, sensor policies specify rules and parameters for sensor-related behaviors, such as selection of sensors and sensor recipes for providing sensor data. According to various implementations, sensor policies can be specific to particular types and/or instances of sensors, and may specify rules and parameters for selection of sensors based on different contexts. Examples of different sensor policies that may be employed are discussed above.

In at least some implementations, the type of sensor data requested can be used to locate sensor policy to be applied. For instance, sensor data type can be used as a lookup attribute for locating corresponding sensor policy. Consider, for example, that a functionality requests location data for a computing device. The sensor hub 120 can query for sensor policies that apply for location requests and/or location sensors, and thus sensor policies that are correlated to location requests/location sensors can be located and utilized to select a sensor recipe for the request for device location.

Step 906 selects a sensor recipe based on the sensor policies. Application of the context to the sensor policies, for example, may indicate one or more sensor types and/or sensor recipes that comply with the sensor policies, and thus may be utilized to provide sensor data in response to the request. As discussed herein, a sensor recipe generally includes one or more instances of sensors that may provide the particular types of sensor data. Examples of different sensor recipes are discussed above.

Step 908 enables the particular type of sensor data to be provided to the requesting functionality from a sensor identified as part of the sensor recipe. The sensor hub 120, for instance, may notify sensor systems specified in the sensor recipe to send sensor data. In at least some implementations, the sensor hub 120 may function as a sensor data router such that sensor data is received by the sensor hub 120 from a sensor system, and is then routed from the sensor hub 120 to a requesting functionality. Alternatively or additionally, the sensor hub 120 may broker communication of sensor data from a sensor system to a requesting functionality without routing the actual sensor data itself.

In at least some implementations, aspects of the methods described above are invisible to a functionality that is requesting sensor data. For instance, an operating system and/or other functionality may simply submit a request to the sensor hub for a particular type of sensor data. The sensor hub may then apply context to relevant sensor policy to identify a candidate sensor recipe for providing the sensor data (e.g., as described above with reference to steps 902, 904, 906) independent of the requesting functionality. The sensor hub then notifies sensors identified in the recipe to send sensor data for the requesting functionality. The sensor data may be provided to the requesting functionality without involvement of the requesting functionality in selection of the particular sensors that provide the sensor data. Thus, based on different contexts and different sensor policies, different sensors and sensor systems can be employed to provide a particular type and/or combination of sensor data.

Having considered the foregoing example procedures, consider now a discussion of example systems and devices that may be employed to implement aspects of techniques discussed herein in one or more embodiments.

Example System and Device

FIG. 10 illustrates an example system generally at 1000 that includes an example computing device 1002 that is representative of one or more computing systems and/or devices that may implement various techniques described herein. For example, the computing device 102 discussed above can be embodied as the computing device 1002. The computing device 1002 may be, for example, a server of a service provider, a device associated with the client (e.g., a client device), an on-chip system, and/or any other suitable computing device or computing system.

The example computing device 1002 as illustrated includes a processing system 1004, one or more computer-readable media 1006, and one or more Input/Output (I/O) Interfaces 1008 that are communicatively coupled, one to another. Although not shown, the computing device 1002 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1004 is representative of functionality to perform one or more operations using hardware. Accordingly, the processing system 1004 is illustrated as including hardware element 1010 that may be configured as processors, functional blocks, and so forth. This may include implementation in hardware as an application specific integrated circuit or other logic device formed using one or more semiconductors. The hardware elements 1010 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1006 is illustrated as including memory/storage 1012. The memory/storage 1012 represents memory/storage capacity associated with one or more computer-readable media. The memory/storage 1012 may include volatile media (such as random access memory (RAM)) and/or nonvolatile media (such as read only memory (ROM), Flash memory, optical disks, magnetic disks, and so forth). The memory/storage 1012 may include fixed media (e.g., RAM, ROM, a fixed hard drive, and so on) as well as removable media (e.g., Flash memory, a removable hard drive, an optical disc, and so forth). The computer-readable media 1006 may be configured in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1002 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1002. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1002, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1010 and computer-readable media 1006 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1010. The computing device 1002 may be configured to implement particular instructions and/or functions corresponding to the software and/or hardware modules. Accordingly, implementation of modules that are executable by the computing device 1002 as software may be achieved at least partially in hardware, e.g., through use of computer-readable storage media and/or hardware elements 1010 of the processing system. The instructions and/or functions may be executable/operable by one or more articles of manufacture (for example, one or more computing devices 1002 and/or processing systems 1004) to implement techniques, modules, and examples described herein.

As further illustrated in FIG. 10, the example system 1000 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1000, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1002 may assume a variety of different configurations, such as for computer 1014, mobile 1016, and television 1018 uses. Each of these configurations includes devices that may have generally different constructs and capabilities, and thus the computing device 1002 may be configured according to one or more of the different device classes. For instance, the computing device 1002 may be implemented as the computer 1014 class of a device that includes a personal computer, desktop computer, a multi-screen computer, laptop computer, netbook, and so on.

The computing device 1002 may also be implemented as the mobile 1016 class of device that includes mobile devices, such as a mobile phone, portable music player, portable gaming device, a tablet computer, wearable devices, a multi-screen computer, and so on. The computing device 1002 may also be implemented as the television 1018 class of device that includes devices having or connected to generally larger screens in casual viewing environments. These devices include televisions, set-top boxes, gaming consoles, and so on.

The techniques described herein may be supported by these various configurations of the computing device 1002 and are not limited to the specific examples of the techniques described herein. For example, functionalities discussed with reference to the sensor systems 110 and/or the sensor hub 120 may be implemented all or in part through use of a distributed system, such as over a “cloud” 1020 via a platform 1022 as described below.

The cloud 1020 includes and/or is representative of a platform 1022 for resources 1024. The platform 1022 abstracts underlying functionality of hardware (e.g., servers) and software resources of the cloud 1020. The resources 1024 may include applications and/or data that can be utilized while computer processing is executed on servers that are remote from the computing device 1002. Resources 1024 can also include services provided over the Internet and/or through a subscriber network, such as a cellular or Wi-Fi network.

The platform 1022 may abstract resources and functions to connect the computing device 1002 with other computing devices. The platform 1022 may also serve to abstract scaling of resources to provide a corresponding level of scale to encountered demand for the resources 1024 that are implemented via the platform 1022. Accordingly, in an interconnected device embodiment, implementation of functionality described herein may be distributed throughout the system 1000. For example, the functionality may be implemented in part on the computing device 1002 as well as via the platform 1022 that abstracts the functionality of the cloud 1020.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A system comprising:
sensor systems that each include one or more sensors; and
a sensor hub operably connected to the sensor systems and configured to receive and process sensor input from the sensor systems independent of a central processing unit (CPU) of an associated computing device, the sensor hub being further configured to execute logic including:
sensor recipes that each define a set of one or more of the sensor systems, at least one of the sensor recipes including sensors from different sensor systems; and
sensor polices that specify parameters for determining which of the sensor recipes is to be used to provide sensor input based on particular contexts.

2. A system as recited in claim 1, wherein the sensor hub is implemented as at least part of a system on a chip (SoC).

3. A system as recited in claim 1, wherein the sensor hub is configured to execute the logic while the CPU is in at least one of a low power or off mode.

4. A system as recited in claim 1, wherein the sensor hub is implemented in a separate power domain from the CPU.

5. A system as recited in claim 1, wherein the sensor hub is further configured to execute logic while the CPU is inactive to perform operations comprising:
receiving sensor data indicating sensor input to one or more of the sensor systems; and
processing the sensor data based on input context and one or more of the sensor policies to ascertain whether a wake event is to be generated to wake the CPU.

6. A system as recited in claim 1, wherein the sensor hub is further configured to execute logic to perform operations comprising:
ascertaining a context of a request from a functionality for a particular type of sensor data; and
applying the context of the request to one or more of the sensor policies; and
selecting at least one of the sensor recipes based on application of the context to the one or more of the sensor policies, wherein the at least one of the sensor recipes specifies one or types of sensors to be used to provide the particular type of sensor data.

7. A system as recited in claim 6, wherein the operations further comprise:
identifying one or more of the sensor systems that correspond to the one or types of sensors to be used to provide the particular type of sensor data; and
routing the particular type of sensor data from the one or more of the sensor systems to the functionality.

8. A system as recited in claim 6, wherein the operations are performed independent of the CPU.

9. A sensor hub comprising:
at least one processing unit; and
instructions stored on the sensor hub that are executable by the at least one processing unit to perform operations including:
ascertaining a context of a request for sensor data; and
applying the context of the request to one or more sensor policies to select a sensor recipe that specifies one or types of sensors to be used to provide the sensor data.

10. A sensor hub as recited in claim 9, wherein the sensor hub is installed on a computing device, and wherein the sensor hub is configured to perform the operations independent of a central processing unit (CPU) of the computing device.

11. A sensor hub as recited in claim 9, wherein the sensor recipe specifies at least two different sensor systems that are to be used to provide the sensor data.

12. A sensor hub as recited in claim 9, wherein the request for sensor data is received from an operating system (OS) of a computing device on which the sensor hub is installed, and wherein the sensor hub is configured to select the sensor recipe and identify one or more sensor systems that correspond to the one or more types of sensors independently of the OS.

13. A sensor hub as recited in claim 12, wherein the operations further include routing the sensor data from the one or more sensor systems to the OS.

14. A sensor hub as recited in claim 9, wherein the operations further include:
receiving sensor data indicating sensor input to one or more sensor systems while a central processing unit (CPU) of an associated computing device is inactive; and
processing the sensor data based on context of the sensor input and one or more of the sensor policies to ascertain whether a wake event is to be generated to wake the CPU.

15. A computer-implemented method comprising:
receiving a request from a functionality for a particular type of sensor data;
ascertaining a context of the request including one or more state conditions that pertain to the request; and
applying the context of the request to one or more sensor policies for the particular type of sensor data to identify a sensor recipe that specifies one or more sensors to be used to provide the particular type of sensor data.

16. A computer-implemented method as recited in claim 15, wherein the functionality comprises an operating system (OS), and where said ascertaining and said applying are performed independent of the OS.

17. A computer-implemented method as recited in claim 15, wherein the one or more state conditions comprise at least one of environmental state conditions or computing device state conditions for a computing device on which the functionality resides.

18. A computer-implemented method as recited in claim 15, wherein the one or more sensor policies specify one or more types of sensors that are not permitted to be used to provide the particular type of sensor data based on the context, and wherein the method further comprises identifying the sensor recipe based at least in part on the sensor recipe not including the one or more types of sensors that are not permitted to be used.

19. A computer-implemented method as recited in claim 15, wherein the sensor recipe includes sensors from different sensor systems.

20. A computer-implemented method as recited in claim 15, further comprising routing the particular type of sensor data from the one or more sensors to the requesting functionality.
